(19) United States
(12) Patent Application Publication
(10) Pub. No.: US 2013/0205573 A1
(43) Pub. Date: Aug. 15, 2013

(54) Blind Nut and Mounting Method thereof

(71) Applicant: Newfrey LLC, (US)

(72) Inventor: Shuuji Kashimura, Toyohashi-shi (JP)

(73) Assignee: Newfrey LLC, Newark, DE (US)

(21) Appl. No.: 13/761,314

(22) Filed: Feb. 7, 2013

(30) Foreign Application Priority Data
Feb. 7, 2012 (JP) 2012-23593

(51) Int. Cl. F16B 39/284

(52) U.S. Cl. CPC F16B 39/284
USPC 29/523; 411/34

(57) ABSTRACT

A blind nut includes an internal threaded portion, a hollow tube-shaped portion adjacent to the internal threaded portion, and a flange with an opening provided at the opposite end of the internal threaded portion. The internal threaded portion and the tube-shaped portion are inserted into the mounting hole of a member. The tube-shaped portion includes a first tube-shaped portion adjacent to the internal threaded portion and having a thickness less than that of the internal threaded portion, and a second tube-shaped portion between the first tube-shaped portion and the flange having a thickness less than that of the first tube-shaped portion. A part of the second tube-shaped portion is plastically deformed so as to enlarge the diameter, the deformation of the second tube-shaped portion elastically deforms the first tube-shaped portion so as to enlarge the diameter, mounting the nut to the member.

### CROSS-REFERENCE TO RELATED APPLICATIONS

This application claims priority from Japanese Patent Application No. 2012-23593, filed on Feb. 7, 2012, the disclosure of which is incorporated herein by reference.

### BACKGROUND OF THE INVENTION

The present invention relates to a blind nut. The present invention relates more specifically to a blind nut able to be mounted on members such as sheets of a wide range of thicknesses.

A blind nut has an internal threaded portion, a tube-shaped portion continuous with the internal threaded portion, and a flange in the end portion of the tube-shaped portion. When the blind nut has been inserted into a hole in a member, a fastening tool is used to buckle the tube-shaped portion so as to expand the diameter, thereby interposing the member between the buckled tube-shaped portion and the flange, and securing the blind nut to the member. The external threading of a bolt can be screwed into the internal threading of the blind nut to mount another member.

FIG. 1 shows a blind nut of the prior art. FIG. 1A is a cross-sectional view showing a blind nut 10 of the prior art set into a mounting hole 43 in a member 41 (thickness t1). The blind nut 10 has a cylindrical shape and is axially symmetrical around the central axis. It has an internal threaded portion 11 on one end. The internal threaded portion 11 has a cylindrical shape and internal threading 15 is formed on the inside. External threading on a fastening tool can be screwed into the internal threading 15. The tube-shaped portion 12 continuous with the internal threaded portion 11 has a cylindrical shape. This is thinner than the internal threaded portion 11, and buckles when mounted on a member 41. The blind nut 10 has a flange 14 at the opposite end of the internal threaded portion 11. The external diameter of the flange 14 is greater than the internal diameter of the mounting hole 43 in the member 41. When the blind nut 10 is inserted into the mounting hole 43 in the member 41, the bottom face of the flange 14 makes contact with the upper face of the member 41 and is stopped. A through-hole 16 is formed from the flange 14 side end portion to the internal threaded portion 11 side end portion. The inner diameter of the through-hole 16 remains constant from the flange 14 side end portion to and through the tube-shaped portion 12, but becomes smaller at the internal threaded portion 11.

FIG. 1B is a cross-sectional view showing the blind nut 10 mounted on the member 41. When the blind nut 10 is mounted using a fastening tool, the thin tube-shaped portion 12 buckles so that its diameter is enlarged, and becomes the expanded diameter portion 12a. The member 41 is interposed between the expanded diameter portion 12a and the flange 14, and the blind nut 10 is mounted on the member 41.

The length of the tube-shaped portion 12 can be changed in order to be able to mount one type of blind nut to members such as sheets with a wide range of thicknesses. FIG. 2A is a cross-sectional view showing a blind nut 10 before mounting in a thin sheet-like member 54 (thickness t2, t1>t2), and FIG. 2B is a cross-sectional view showing the blind nut 10 after mounting on the thin sheet-like member 54. As shown in FIG. 2B], when the length of tube-shaped portion 12 is too great relative to the thickness of the thin sheet-like member 54 and the blind nut 10 is mounted, the expansion of the diameter of the thin tube-shaped portion 12 is not uniform around its entire circumference and does not become an expanded diameter portion such as that shown in expanded diameter portion 12a. Also, a portion of 12 may buckle inward and deform abnormally as shown in portion 12b of FIG. 2B.

In order to mount a blind nut in members of different thicknesses without abnormal deformation, blind nuts having tube-shaped portions of different lengths have to be prepared based on the thickness of the member. Thus, a type of blind nut is desired that can be mounted without any problem on members such as panels having a wide range of thicknesses.

A blind nut is disclosed in Japanese Laid-Open Utility Model Publication No. 58-162312 which has an internal threaded portion, a tube-shaped portion, and a flange. The tube-shaped portion is inserted into a hole in a panel and buckled to secure the panel between the flange and the buckled tube-shaped portion. In this blind nut, the diameter of the hole in the tube-shaped portion gradually narrows from the flange to the internal threaded portion. Because the thickness of the tube-shaped portion of the blind nut in Japanese Laid-Open Utility Model Publication No. 58-162312 gradually increases from the flange to the internal threaded portion, the portion near the flange is more easily deformed. As a result, the blind nut in Patent Document 1 can be secured to a panel of any thickness.

However, in the blind nut of Japanese Laid-Open Utility Model Publication No. 58-162312, the location where the buckling of the tube-shaped portion takes place depends on the thickness of the panel. Therefore, when the panel is thick, the buckling occurs from a relatively thick part of the tube-shaped portion, and the load increases when the blind nut is mounted. A buckling abnormality is more likely to occur when the buckling occurs in a relatively thick part of the tube-shaped portion, and the diameter of the tube-shaped portion does not expand sufficiently.

A blind nut is disclosed in Japanese Laid-Open Patent Publication No. 9-242728 which has a shank, a flange, and a threaded bore. The bore in a first portion of the shank near the flange has a large diameter, a second portion has an intermediate diameter, and the bore in a third portion far from the flange has a small diameter. In Japanese Laid-Open Patent Publication No. 9-242728, the first portion of the shank is deformed to secure a first body between the first portion and the flange, and the second portion is deformed to secure a second body between the first portion and the second portion. In Japanese Laid-Open Patent Publication No. 9-242728, the first portion and the second portion can be gradually deformed to secure two bodies (members) with space between them.

However, in Japanese Laid-Open Patent Publication No. 9-242728, a different pull rod has to be used when the first body is secured than when the second body is secured. This makes the fastening operation more complicated. The invention in Japanese Laid-Open Patent Publication No. 9-242728 is used to mount two bodies with space between them. It cannot fasten members with a wide range of thicknesses.

Thus, one type of blind nut is desired that can be mounted without any problem on members such as panels having a wide range of thicknesses. Also, a blind nut is desired that can be reliably mounted on a member by sufficiently widening the diameter of the tube-shaped portion.

### PRIOR ART DOCUMENTS

Patent Document 1—Laid-Open Utility Model Publication No. 58-162312.

Patent Document 2—Laid-Open Patent Publication No. 9-242728.

### SUMMARY OF THE INVENTION

Therefore, a purpose of the present invention is to provide one type of blind nut that can be mounted without any problem on members such as panels having a wide range of thicknesses. Another purpose of the present invention is to provide a blind nut that can be reliably mounted on a member by sufficiently widening the diameter of the tube-shaped portion.

In order to achieve this purpose, the present invention includes a tube-shaped portion (diameter-widened portion) which has a thick portion and a thin portion. First, the diameter of the thin portion is widened. Next, the diameter of the thick portion is widened. This prevents any buckling mishap, even when the blind nut is mounted on a member such as a thin sheet.

A first aspect of the present invention is related to a blind nut including an internal threaded portion having internal threading on the inside, a hollow tube-shaped portion adjacent to the internal threaded portion, and a flange with an opening provided at the opposite end of the internal threaded portion. Here, the internal threaded portion and the tube-shaped portion are inserted into a mounting hole in a member, and a part of the tube-shaped portion is plastically deformed so as to enlarge the diameter, thereby securing the member between the deformed expanded diameter portion and the flange, and mounting the nut on the member. The tube-shaped portion of this blind nut has a first tube-shaped portion adjacent to the internal threaded portion and having a thickness less than that of the internal threaded portion, and a second tube-shaped portion positioned between the first tube-shaped portion and the flange having a thickness less than that of the first tube-shaped portion.

In this way, the blind nut is reliably secured to a member without any buckling mishap. Also, because the outer diameter of the expanded diameter portion can be sufficiently enlarged by plastic deformation, the securing strength is increased, and the nut is reliably secured.

Preferably, when a part of the tube-shaped portion is plastically deformed so as to enlarge the diameter, a part of the second tube-shaped portion is plastically deformed so as to enlarge the diameter, the deformation of the second tube-shaped portion elastically deforms the first tube-shaped portion so as to enlarge the diameter, and the member is secured between the flange and the expanded diameter portion obtained by plastically deforming the first tube-shaped portion and the second tube-shaped portion. Because the thin second tube-shaped portion buckles under a low load and its diameter expands, a buckling mishap is less likely to occur. Because the diameter of the thick first tube-shaped portion is pulled by the thin second tube-shaped portion and its diameter expands, a buckling mishap is less likely to occur.

Preferably, the internal threaded portion, the first tube-shaped portion, and the second tube-shaped portion have the same outer diameter.

Preferably, a plurality of knurled grooves extending longitudinally are formed on the outer face of the first tube-shaped portion and the second tube-shaped portion. When the blind nut is mounted on a member and then mounted on another member, a portion of the knurled grooves makes contact with the member and this keeps the blind nut from rotating with respect to the member.

Preferably, the transverse section of the outer face of the second tube-shaped portion is formed in a hexagonal shape or a rectangular shape. By inserting and mounting the blind nut in a hexagonal or rectangular mounting hole in the member, the blind nut can be kept from rotating with respect to the member.

A second aspect of the present invention relates to a method for mounting a blind nut on a member, the blind nut including an internal threaded portion having internal threading on the inside, a hollow tube-shaped portion adjacent to the internal threaded portion, and a flange with an opening provided at the opposite end of the internal threaded portion, and the tube-shaped portion including a first tube-shaped portion adjacent to the internal threaded portion and having a thickness less than that of the internal threaded portion, and a second tube-shaped portion positioned between the first tube-shaped portion and the flange having a thickness less than that of the first tube-shaped portion. In this method, the internal threaded portion and the tube-shaped portion are inserted into a mounting hole in the member, a part of the second tube-shaped portion is plastically deformed so as to enlarge the diameter, the deformation of the second tube-shaped portion plastically deforming the first tube-shaped portion so as to enlarge the diameter, and the member is secured between the flange and the expanded diameter portion obtained by plastically deforming the first tube-shaped portion and the second tube-shaped portion, thereby mounting the blind nut on the member.

The present invention is able to provide one type of blind nut that can be mounted without any problem on members such as panels having a wide range of thicknesses. The present invention is also able to provide a blind nut that can be reliably mounted on a member by sufficiently widening the diameter of the tube-shaped portion.

### BRIEF DESCRIPTION OF THE DRAWINGS

FIG. 1A is a cross-sectional view showing a blind nut of the prior art set into a member, and FIG. 1B is a cross-sectional view showing the blind nut mounted on the member.

FIG. 2A is a cross-sectional view showing a blind nut of the prior art set into a thin sheet member, and FIG. 2B is a cross-sectional view showing the blind nut mounted on the thin sheet member.

FIG. 3 is a cross-sectional front view of a portion of a blind nut according to a first embodiment of the present invention.

FIG. 4 is a perspective view showing the fastening tool used in the present invention.

FIG. 5 is a front view showing the tip portion of the fastening tool used in the present invention.

FIG. 6A is a cross-sectional front view of the blind nut set into the member.

FIG. 6B is a cross-sectional front view after the fastening tool has been set and the mounting operation for the blind nut has started.

FIG. 6C is a cross-sectional front view as the mounting operation for the blind nut continues.

FIG. 6D is a cross-sectional front view after the member with the mounted blind nut has been removed from the fastening tool.

FIG. 7 is a cross-sectional view showing another member mounted in the blind nut mounted to the member using a bolt.

FIG. 8A is a cross-sectional view showing the dimensional measurements of a blind nut of the prior art and FIG. 8B is a blind nut according to the first embodiment of the present invention.

FIG. 9 is a cross-sectional front view of a portion of a blind nut according to a second embodiment of the present invention.

FIG. 10 is a cross-sectional front view of a portion of a blind nut according to a third embodiment of the present invention.

FIG. 11 is a cross-sectional front view of a portion of a blind nut according to a fourth embodiment of the present invention.

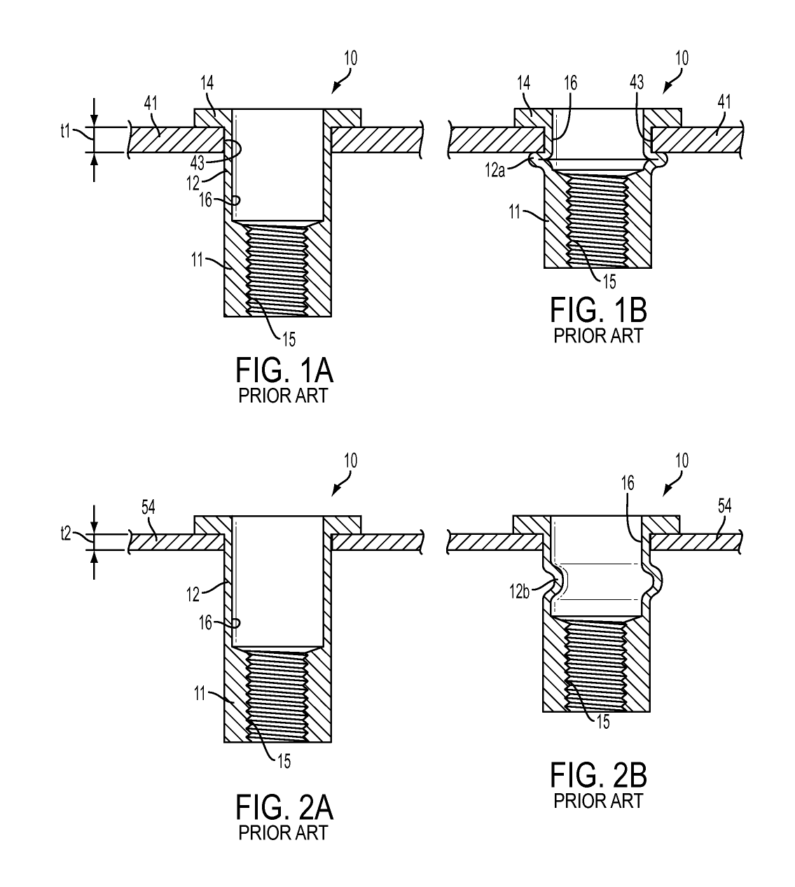

### DETAILED DESCRIPTION OF THE PREFERRED EMBODIMENTS

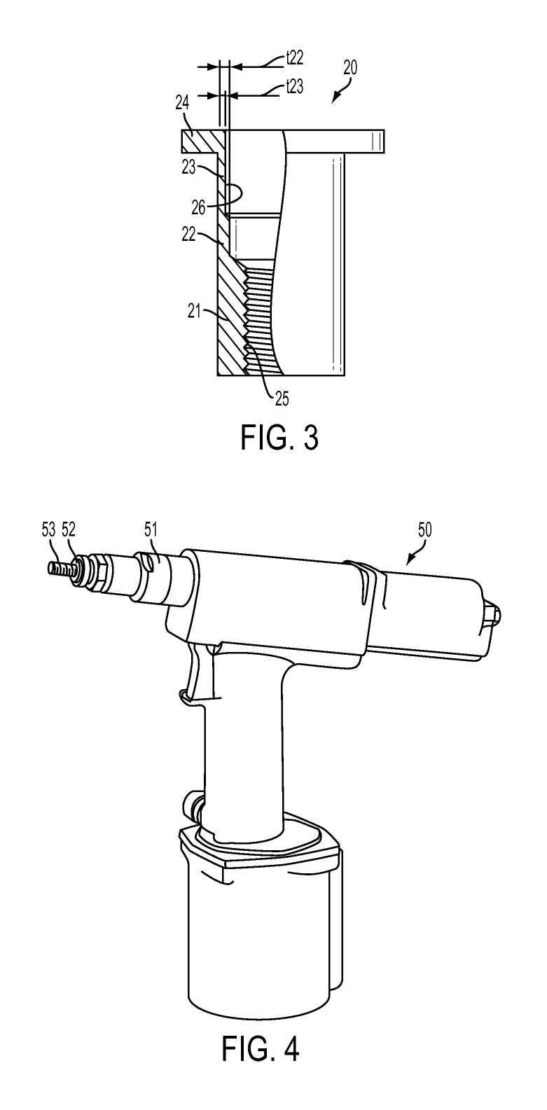

The following is an explanation of a blind nut 20 according to a first embodiment of the present invention with reference to the drawings. FIG. 3 is a cross-sectional front view of a portion of a blind nut 20 according to a first embodiment of the present invention. The blind nut 20 has a cylindrical shape and is axially symmetrical around the central axis. It has an internal threaded portion 21 on one end. The internal threaded portion 21 has a cylindrical shape and internal threading 25 is formed on the inside. External threading on a fastening took can be screwed into the internal threading 25. After the blind nut 20 has been attached, the external threading of a bolt can be screwed in to mount another member. The tube-shaped portion adjacent to the internal threaded portion 21 has a first tube-shaped portion 22 adjacent the internal threaded portion 21 having a thickness less than that of the internal threaded portion 21 (thickness t22), and a second tube-shaped portion 23 adjacent to the first tube-shaped portion 22 having a thickness less than even that of the first tube-shaped portion 22 (thickness t23, t22>t23). The internal threaded portion 21, the first tube-shaped portion 22, and the second tube-shaped portion 23 have the same outer diameter. The first tube-shaped portion 22 and the second tube-shaped portion 23 are portions that buckle when mounted on a member 41. The blind nut 20 has a flange 24 adjacent to the second tube-shaped portion 23 on the opposite end from the internal threaded portion 21. The outer diameter of the flange 24 is greater than the outer diameter of the second tube-shaped portion 23 and greater than the inner diameter of the mounting hole 43 in the member 41.

The blind nut 20 is inserted into the mounting hole 43 in the member 41 with the internal threaded portion 21 in front. It comes to a stop when the bottom face of the flange 24 comes into contact with the upper face of the member 41. A through-hole 26 is formed from the flange 24 side end portion to the internal threaded portion 21 end portion. The inner diameter of the through-hole 26 is constant from the flange 24 side end portion to the second tube-shaped portion 23. In the first tube-shaped portion 22, the inner diameter is smaller than that of the second tube-shaped portion 23. In the internal threaded portion 21, the inner diameter is even smaller. In FIG. 3, the first tube-shaped portion 22, the second tube-shaped portion 23, and the internal threaded portion 21 have the same outer diameter. This is smaller than the inner diameter of the mounting hole 43 in the member 41, allowing for easy insertion into the mounting hole 43 in the member 41. If necessary, the outer diameter of the first tube-shaped portion 22, the second tube-shaped portion 23, and the internal threaded portion 21 can be different.

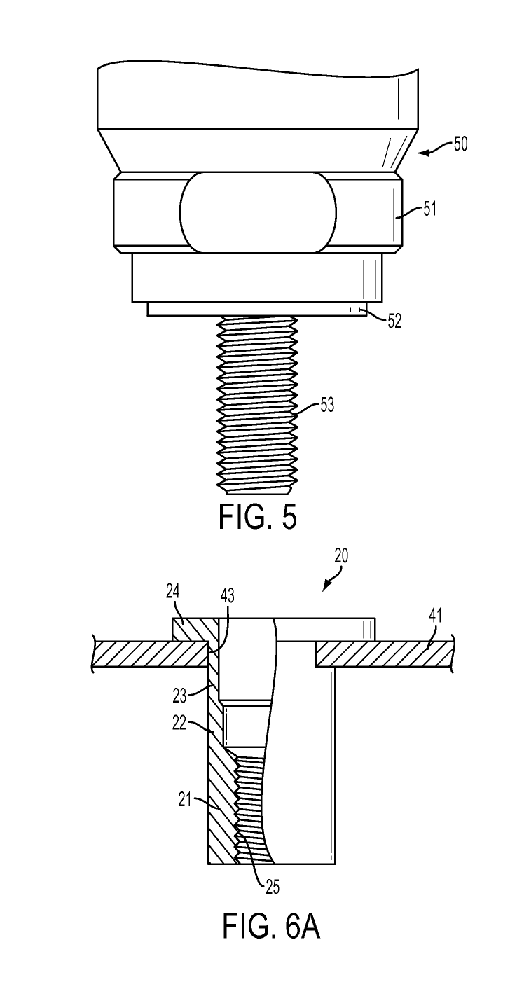

FIG. 4 and FIG. 5 are diagrams showing the fastening tool used in the embodiments of the present invention. FIG. 4 is a perspective view showing the fastening tool 50 used in the embodiments of present invention. The power source of the fastening tool 50 is compressed air. Adjacent to the main body portion 51 are a nosepiece 52 for supporting the component to be fastened, and a screw mandrel 53 with external threading at the tip. A rotating body (not shown) is rotated, the screw mandrel 53 at the tip is rotated, and screwing or unscrewing is performed. The screw mandrel 53 can also be firmly engaged without rotation.

FIG. 5 is a front view showing the tip portion of the fastening tool 50. The main body portion 51 of the fastening tool 50 has a nosepiece 52 which applies pressure to the member. The bottom face of the nosepiece 52 is flat. A screw mandrel 53 with external threading formed on the outer column-shaped periphery extends forward (downward in FIG. 5) in the central portion of the nosepiece 52.

The outer diameter of the screw mandrel 53 is smaller than the inner diameter of the through-hole 26 in the first tube-shaped portion 22 and second tube-shaped portion 23 of the blind nut 20 so that it can be inserted into the through-hole 26. The external threading of the screw mandrel 53 has an outer diameter which allows the internal threading 25 of the internal threaded portion 21 of the blind nut 20 to be engaged. In the fastening tool 50, the screw mandrel 53 can be rotated in the forward or reverse direction to engage or disengage the internal threading 25 of the internal threaded portion 21. The screw mandrel 53 can also be firmly engaged without rotation when the flange 24 of the blind nut 20 is supported by the nosepiece 52.

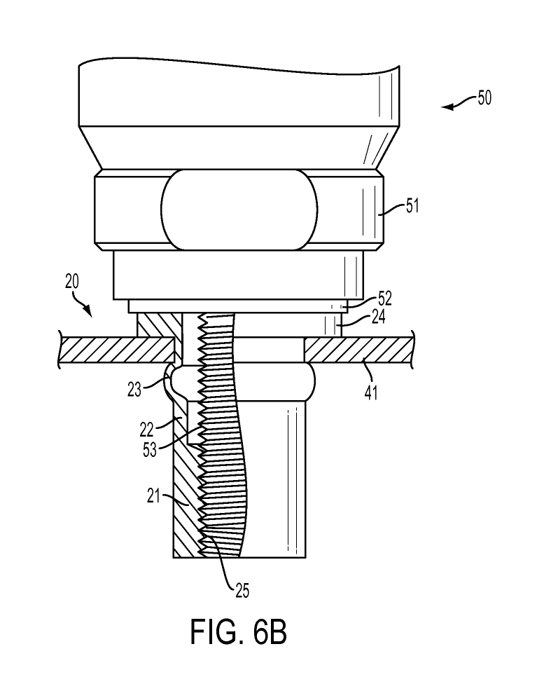

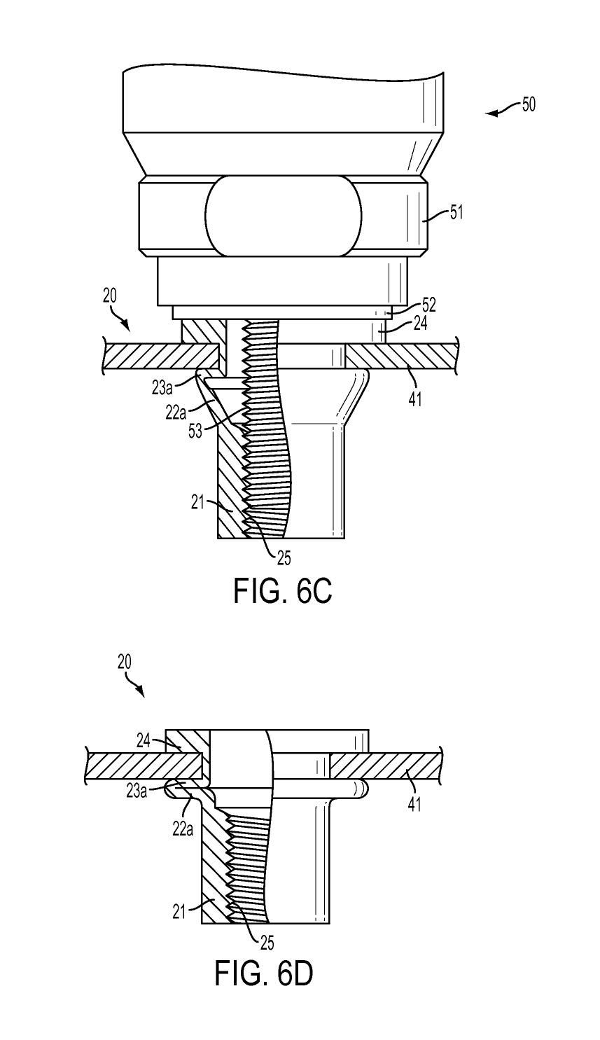

The following is an explanation of the operations performed to mount a blind nut 20 on a member 41 with reference to FIG. 6A through FIG. 6D. FIG. 6A is a cross-sectional front view of the blind nut 20 set into the member 41. The blind nut 20 is inserted into a mounting hole 43 in the member 41 from the internal threaded portion 21, and the bottom face of the flange 24 is brought into contact with the upper face of the member 41.

FIG. 6B is a cross-sectional front view after the fastening tool 50 has been set and the mounting operation for the blind nut 20 has started. The screw mandrel 53 is inserted into the through-hole 26 in the blind nut 20, the screw mandrel 53 is rotated in the forward direction, and the external threading of the screw mandrel 53 is screwed into the internal threading 25 of the internal threaded portion 21. When the external threading of the screw mandrel 53 has been screwed into the internal threading 25 to a predetermined length, the bottom face of the nosepiece 52 of the fastening tool 50 comes into contact with the upper face of the flange 24 of the blind nut 20, and the screw mandrel 53 stops rotating.

When the bottom face of the nosepiece 52 of the fastening tool 50 has come into contact with and is supported by the flange 24 of the blind nut 20, it is firmly engaged on the main body 51 side without the screw mandrel 53 rotating. At this time, the bottom face of the nosepiece 52 pushes down against and is supported by the flange 24 of the blind nut 20, and the screw mandrel 53 pulls the internal threading 21 upwards. In FIG. 6B, a part of the second tube-shaped portion 23, which is the thin portion of the blind nut 20 (the portion extending out from the mounting hole 43 in the member 41), begins to buckle and become plastically deformed so that its diameter expands.

FIG. 6C is a cross-sectional front view as the mounting operation for the blind nut 20 continues. The second tube-shaped portion 23 continues to be plastically deformed and becomes expanded diameter portion 23a. The first tube-shaped portion 22, which is thicker than the second tube-shaped portion 23, also begins to be plastically deformed so that its diameter expands. The second tube-shaped portion 23 is inside the mounting hole 43 in the member 41, and its outer diameter is restricted by the mounting hole 43. As a result, it cannot expand in diameter beyond the inner diameter of the mounting hole 43. The second tube-shaped portion 23 expands in diameter in the part lower than the bottom face of the member 41, and comes into contact with the bottom face surrounding the mounting hole 43 in the member 41. This is pulled, and the thicker first tube-shaped portion 22 expands in diameter such that the upper end portion opens.

The first tube-shaped portion 22 continues to be plastically deformed, the resulting expanded diameter portion 22a overlaps with expanded diameter portion 23a, and the member 41 is interposed and secured between the expanded diameter portions 22a, 23a and the flange 24. When the fastening operation has been completed with the fastening tool 50, the screw mandrel 53 is rotated in the reverse direction, which is opposite that of FIG. 6B, and the external threading of the screw mandrel 53 is unscrewed from the internal threading 25 of the internal threaded portion 21. After the threading has been unscrewed, the fastening tool 50 is removed from above. FIG. 6D is a cross-sectional front view after the member 41 with the mounted blind nut 20 has been removed from the fastening tool 50.

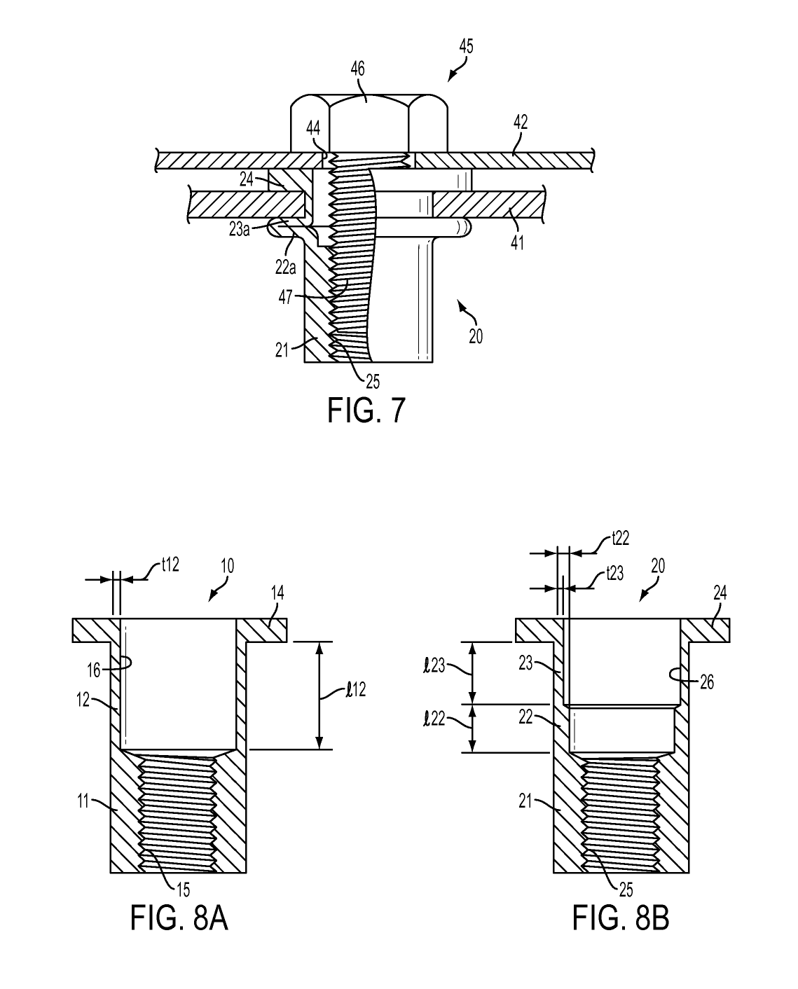

FIG. 7 is a cross-sectional view showing another member 42 mounted in the blind nut 20 mounted to the member 41 using a bolt. A bolt 45 with a head portion 46 and a shaft portion 47 is prepared. The external threading of the shaft portion 47 can be screwed into the internal threading 25 of the internal threaded portion 21 of the blind nut 20. The through-hole 26 in the blind nut 20 is aligned with the mounting hole 44 in the other member 42, and the member 42 is arranged on the flange 24 of the blind nut 20. The shaft portion 47 of the bolt 45 is passed through the mounting hole 44 in the other member 42, and inserted into the through-hole 26 in the blind nut 20. The external threading of the shaft portion 47 of the bolt 45 is screwed into the internal threading 25 of the internal threaded portion 21 of the blind nut 20, and the other member 42 is mounted in the blind nut 20. In FIG. 7, the other member 42 is mounted on the flange 24 side of the blind nut 20, but the other member 42 can also be mounted on the internal threaded portion 21 side of the blind nut 20 (the lower side in FIG. 7), which is on the opposite side of that shown in FIG. 7 (not shown).

In the first embodiment of the present invention, when the blind nut 20 is mounted, the second tube-shaped portion 23 adjacent to the flange 24 and having a smaller thickness is elastically deformed first so as to expand in diameter. The member 41 is then pressed against, and the first tube-shaped portion 22 having a greater thickness is elastically deformed so as to expand in diameter and reliably secure the member 41. Because the thinner second tube-shaped portion 23 buckles and expands in diameter under a smaller load, it is unlikely to experience a buckling mishap. Because the thicker first tube-shaped portion 22 is pulled up by the thinner second tube-shaped portion 23 to expand in diameter, the diameter expands reliably and a buckling mishap is less likely to occur. Because the outer diameter of the expanded diameter portion is sufficiently large, the securing strength is increased, and the nut is reliably secured.

As for the difference in thickness between the first tube-shaped portion 22 and the second tube-shaped portion 23, when the difference in thickness between the first tube-shaped portion 22 and the second tube-shaped portion 23 is small, the difference in strength between the first tube-shaped portion 22 and the second tube-shaped portion 23 is slight, the second tube-shaped portion 23 is less likely to buckle first, and a buckling mishap sometimes occurs. When the difference in thickness between the first tube-shaped portion 22 and the second tube-shaped portion 23 is too great, the strength with which the thicker first tube-shaped portion 22 is pulled by the thinner second tube-shaped portion 23 is inadequate, and the diameter of the first tube-shaped portion 22 is difficult to expand. The first tube-shaped portion 22 is preferably 20-30% thicker than the second tube-shaped portion 23. The material of the blind nut 20 is steel, stainless steel or aluminum, and the appropriate thickness for the first tube-shaped portion 22 and the second tube-shaped portion 23 depends on the material.

Blind nuts 20 of steel were tested in the following manner. In the test, a blind nut 10 of the prior art and a blind nut 20 according to the first embodiment of the present invention were mounted in a member, and the outer diameters of the expanded diameter portions were compared. FIG. 8A is a cross-sectional view showing the dimensional measurements of the blind nut 10 of the prior art used in the testing, and FIG. 8B is a cross-sectional view showing the dimensional measurements of the blind nut 20 according to the first embodiment of the present invention used in the testing. These dimensions are shown in Table 1.

TABLE 1

| | Tube-Shaped | | |
|---|---|---|---|
| Blind Nut | Portion | Length (mm) | Thickness (mm) |
| Blind Nut 10 | Tube-Shaped | l12 = 6.8 | t12 = 0.7 |
| (Prior Art) | Portion 12 | | |
| Blind Nut 20 | 1st Tube-Shaped | l22 = 2.5 | t22 = 0.9 |
| (Invention) | Portion 22 | | |
| | 2nd Tube-Shaped | l23 = 6.0 | t23 = 0.7 |
| | Portion 23 | | |

The blind nut 10 of the prior art and the blind nut 20 according to the first embodiment of the present invention were mounted on sheet mounting members 41 having a thickness from 1 to 7 mm, and the outer diameter of the expanded diameter portions was measured. The results are shown in Table 2.

TABLE 2

| | Outer Diameter of | |
|---|---|---|
| | Expanded Diameter | |
| Sheet Thickness | Portion (mm) | Invention |
| of Member (mm) | Prior Art (12a) | (22a, 22b) |
| 1 | 12.54 | 13.54 |
| 2 | 12.07 | 13.19 |
| 3 | 11.47 | 12.75 |
| 4 | 10.58 | 12.32 |
| 5 | — | 11.97 |
| 6 | — | 11.21 |
| 7 | — | 10.21 |

The blind nut 10 of the prior art was used on members with a thickness from 2.5 to 4.0 mm. When mounted in the member with the maximum thickness of 4.0 mm, the outer diameter of the expanded diameter portion was 10.58 mm. The outer diameter of this expanded diameter portion was used as the reference for the required outer diameter for the expanded diameter portion. It is clear from Table 2 that an outer diameter for the expanded diameter portion of up to 10.58 mm was obtained for members up to 6.0 mm in thickness. Therefore, a blind nut of the prior art can be used on a member up to 6.0 mm in thickness.

When mounted on members of the same thickness, the outer diameter of the expanded portions of the blind nuts 20 of the present invention were compared to blind nuts 10 of the prior art. It is clear from Table 2 that the outer diameter of the expanded diameter portions of the blind nuts 20 of the present invention were at least 1 mm greater than the outer diameter of the expanded diameter portions of the blind nuts 10 of the prior art when mounted on members with a thickness from 1 mm to 4 mm. When the outer diameter of the expanded diameter portion is larger, the strength required to pull the blind nut from the member is increased, and the blind nut can be mounted on the member more securely. When the member is made of resin or is a thin metal sheet, the blind nut can be reliably secured.

In the first embodiment of the present invention, a blind nut could be mounted without any problems on members such as sheets with a wide range of thicknesses. Also, the tube-shaped portions of the blind nut expanded in diameter sufficiently, and could be securely mounted to a member.

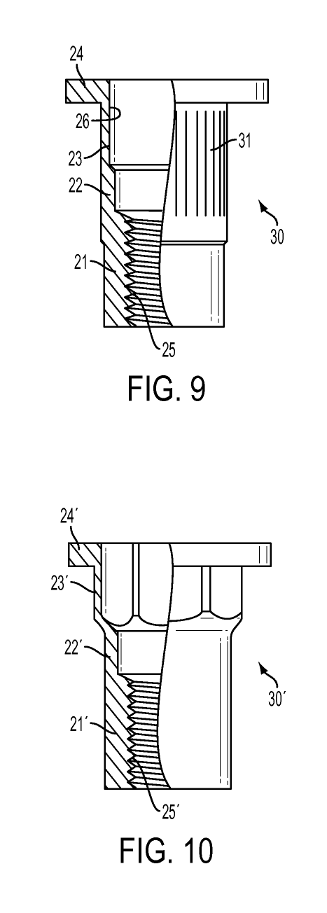

The following is an explanation of the second through fourth embodiments of the present invention with reference to FIG. 9 through FIG. 11. FIG. 9 is a cross-sectional front view of a portion of a blind nut 30 according to a second embodiment of the present invention. The blind nut 30 has an internal threaded portion 21, a first tube-shaped portion 22, a second tube-shaped portion 23, and a flange 24. Internal threading 25 is formed in the internal threaded portion 21, and a through-hole 26 is formed. The first tube-shaped portion 22 is thinner than the internal threaded portion 21, and the second tube-shaped portion 23 is thinner than the first tube-shaped portion 22. The present embodiment differs from the blind nut 20 in the first embodiment in that a plurality of knurled grooves 31 extending longitudinally are formed on the outer face of the first tube-shaped portion 22 and the second tube-shaped portion 23 of the blind nut 30. Also, the first tube-shaped portion 22 and the second tube-shaped portion 23 have a somewhat larger outer diameter than the internal threaded portion 21. In all other respects, it is identical to the blind nut 20 of the first embodiment.

When the blind nut 30 is mounted on a member 41 and the external threading of the screw mandrel 53 is screwed or unscrewed in the internal threading 25 of the internal threaded portion 21, the portion with the knurled grooves 31 is held, and the blind nut 30 is kept from rotating with respect to the member 41. Also, after the blind nut 30 has been mounted on the member 41 and a bolt is screwed into the internal threaded portion 21 to mount another member 42, the portion with the knurled grooves 31 makes contact with the member 41 and keeps the nut from slipping with respect to the member 41.

FIG. 10 is a cross-sectional front view of a portion of a blind nut 30′ according to a third embodiment of the present invention. In this blind nut 30′, the inner face and outer face of the second tube-shaped portion 23′ have a hexagonal transverse section. The flange 24′ is disk-shaped and has a hexagonal hole corresponding to the shape of the second tube-shaped portion 23′. Also, the second tube-shaped portion 23′ has a somewhat larger outer diameter than the internal threaded portion 21′ and the first tube-shaped portion 22′. The rest is identical to the blind nut 20 in the first embodiment. When the blind nut 30′ is mounted on a member 41, the second tube-shaped portion 23′ with a hexagonal cross-section is deformed, and the first tube-shaped portion 22′ with a round cross-section is deformed by the deformation of the second tube-shaped portion 23′.

When the blind nut 30′ has been mounted on a member 41 and a bolt is screwed into the internal threaded portion 21 to mount another member 42, the hexagonal outer face of the second tube-shaped portion 23′ is held, and the blind nut 30′ is kept from slipping with respect to the member 41. The mounting hole 43 of the member 41 should be hexagonal so as to conform to the shape of the second tube-shaped portion 23′.

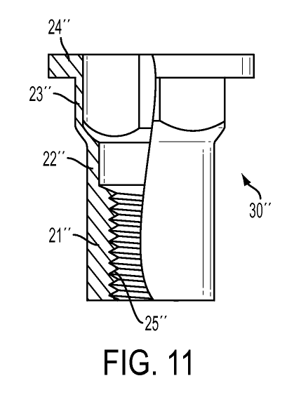

FIG. 11 is a cross-sectional front view of a portion of a blind nut 30″ according to a fourth embodiment of the present invention. In this blind nut 30″, the inner face and outer face of the second tube-shaped portion 23″ have a rectangular transverse section. The flange 24″ is disk-shaped and has a rectangular hole corresponding to the shape of the second tube-shaped portion 23″. Also, the second tube-shaped portion 23″ has a somewhat larger outer diameter than the internal threaded portion 21″ and the first tube-shaped portion 22″. The rest is identical to the blind nut 20 in the first embodiment. When the blind nut 30″ is mounted on a member 41, the second tube-shaped portion 23″ with a rectangular cross-section is deformed, and the first tube-shaped portion 22″ with a round cross-section is deformed by the deformation of the second tube-shaped portion 23″.

When the blind nut 30″ has been mounted on a member 41 and a bolt is screwed into the internal threaded portion 21″ to mount another member 42, the rectangular outer face of the second tube-shaped portion 23″ is held, and the blind nut 30″ is kept from slipping with respect to the member 41. The mounting hole 43 of the member 41 should be rectangular so as to conform to the shape of the second tube-shaped portion 23″.

When in the second through fourth embodiments a bolt is screwed into the internal threaded portion 21 to mount another member 42, the blind nut 30 is kept from slipping with respect to the member 41.

### KEY TO TEXT IN FIGURES

10: Blind nut (prior art)
11: Internal threaded portion
12: Tube-shaped portion
12a: Expanded diameter portion
14: Flange
15: Internal threading
16: Through-hole
20: Blind nut
21: Internal threaded portion
22: First tube-shaped portion
22a: Expanded diameter portion
23: Second tube-shaped portion
23a: Expanded diameter portion
24: Flange
25: Internal threading
26: Through-hole
30, 30′, 30″: Blind nut
31: Knurled groove
41: Member
42: Another member
43: Mounting hole
44: Mounting hole
45: Bolt
46: Head portion
47: Shaft portion
50: Fastening tool
51: Main body portion
52: Nosepiece
53: Screw mandrel
54: Thin sheet-like member

What is claimed is:

1. A blind nut including an internally threaded portion, a hollow tube-shaped portion adjacent to the internally threaded portion, and a flange with an opening provided at the opposite end of the internal threaded portion, the internally threaded portion and the tube-shaped portion being inserted into a mounting hole in a member, and a part of the tube-shaped portion becoming plastically deformed so as to enlarge the diameter, thereby securing the member between the deformed expanded diameter portion and the flange, and mounting the nut on the member;
Wherein the tube-shaped portion includes a first tube-shaped portion adjacent to the internally threaded portion and the first tube-shaped portion having a thickness less than that of the internally threaded portion, and a second tube-shaped portion positioned between the first tube-shaped portion and the flange, the second tube-shaped portion having a thickness less than that of the first tube-shaped portion.

2. The blind nut of claim 1, wherein when a part of the tube-shaped portion is plastically deformed so as to enlarge the diameter, a part of the second tube-shaped portion is plastically deformed so as to enlarge the diameter, the deformation of the second tube-shaped portion elastically deforms the first tube-shaped portion so as to enlarge the diameter, and the member is secured between the flange and the expanded diameter portion obtained by plastically deforming the first tube-shaped portion and the second tube-shaped portion.

3. The blind nut of claim 1, wherein the internally threaded portion, the first tube-shaped portion, and the second tube-shaped portion have the same outer diameter.

4. The blind nut of claim 1, wherein a plurality of knurled grooves extending longitudinally are formed on the outer face of the first tube-shaped portion and the second tube-shaped portion.

5. The blind nut of claim 1, wherein the transverse section of the outer face of the second tube-shaped portion is formed in a hexagonal shape or a rectangular shape.

6. A method of mounting a blind nut onto a member, the blind nut including an internally threaded portion, a hollow tube-shaped portion adjacent to the internally threaded portion, and a flange with an opening provided at the opposite end of the internally threaded portion, and the tube-shaped portion including a first tube-shaped portion adjacent to the internally threaded portion and having a thickness less than that of the internal threaded portion, and a second tube-shaped portion positioned between the first tube-shaped portion and the flange having a thickness less than that of the first tube-shaped portion,
the method having steps comprising:
inserting the internally threaded portion and the tube-shaped portion into a mounting hole in the member,
plastically deforming a part of the second tube-shaped portion so as to enlarge the diameter, the deformation of the second tube-shaped portion plastically deforming the first tube-shaped portion so as to enlarge the diameter, and
securing the member between the flange and the expanded diameter portion by plastically deforming the first tube-shaped portion and the second tube-shaped portion, thereby mounting the blind nut on the member.
